(19) United States
(12) Patent Application Publication
(10) Pub. No.: US 2024/0353609 A1
(43) Pub. Date: Oct. 24, 2024

(54) REFLECTIVE WAVEGUIDE WITH PHASE STEP MITIGATION

(71) Applicant: GOOGLE LLC, Mountain View, CA (US)

(72) Inventors: Alexander Koshelev, San Jose, CA (US); Christophe Peroz, Zollikon (CH)

(21) Appl. No.: 18/640,454

(22) Filed: Apr. 19, 2024

Related U.S. Application Data
(60) Provisional application No. 63/460,667, filed on Apr. 20, 2023.

(51) Int. Cl. F21V 8/00; G02B 5/18; G02B 27/01

(52) U.S. Cl. CPC G02B 6/0038; G02B 5/1814; G02B 5/1861; G02B 6/0016; G02B 27/0172; G02B 2027/011; G02B 2027/0178

(57) ABSTRACT

A waveguide includes a mirror region, a non-mirror region, and a mitigation element. The mitigation element mitigates a phase difference between a first beam portion passing through the mirror region and a second beam portion passing through the non-mirror region. The mitigation element includes, for example, mirrors that are phase matched to the surrounding waveguide core, tapered or serrated mirrors, or phase compensating layers on the surface of the waveguide.

### BACKGROUND

Reflective waveguides typically incorporate a structured array of semi-transparent louver mirrors, strategically positioned to modulate light transmission through partial reflection. This design manipulates the light path to expand the exit pupil, which determines the size of the image visible to the user. By adjusting the orientation and properties of these mirrors, it is possible to expand the pupil in specific directions (i.e., horizontally, vertically, or both) according to the desired field of view. This expansion allows for a wide viewing angle to be achieved, making the technology adaptable for various applications in compact optical systems such as augmented reality (AR) glasses, virtual reality (VR) headsets, heads-up displays (HUDs), and the like. The ability to overlay virtual images onto a user's real-world view is dependent on this precise control of light direction and pupil size. One of the problems encountered with conventional reflective waveguide architectures is that as the light transmits through the mirror, the light acquires a phase step relative to the light that travels through the waveguide core material. This leads to a significant reduction in the image quality (e.g., sharpness, resolution) of the displayed image.

### SUMMARY OF EMBODIMENTS

In accordance with one aspect, a waveguide includes a mirror region, a non-mirror region, and a mitigation element. The mitigation element mitigates a phase difference between a first beam portion passing through the mirror region and a second beam portion passing through the non-mirror region.

In accordance with another aspect, a waveguide grating includes a substrate and a least one mirror. The at least one mirror is formed on the substrate and includes at least one reflective layer formed on the substrate and at least one mitigation element formed on the at least one reflective layer. The at least one mitigation element mitigates a phase difference between a first beam portion passing through the at least one reflective layer and a second beam portion passing through a non-mirror region of a waveguide.

In accordance with a further aspect, a wearable head-mounted display system includes a waveguide, an image source to project light comprising an image, and at least one lens element. The waveguide includes a mirror region, a non-mirror region, and a mitigation element. The mitigation element mitigates a phase difference between a first beam portion passing through the mirror region and a second beam portion passing through the non-mirror region.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating a cross-sectional view of a portion of a reflective waveguide, which includes a phase step for different portions of a light beam passing through a mirror and a non-mirror region of the waveguide.

FIG. 2 is a graph illustrating the propagation of an unfolded beam along a one-dimensional reflective waveguide.

FIG. 3 is a graph illustrating an example number of times each ray within a light beam intersects a mirror of a reflective waveguide.

FIG. 4 is a graph illustrating example point spread function calculated for different values of individual mirror phase step.

FIG. 5 is a graph illustrating an example modular transfer function calculated for different amounts of individual mirror phase step based on the point spread function of FIG. 4.

FIG. 6 is a diagram illustrating a cross-sectional view of a portion of a reflective waveguide implementing phase matching between the mirror coating and waveguide core material in accordance with some embodiments.

FIG. 7 is a diagram illustrating a cross-sectional view of a reflective waveguide mirror implementing a hybrid phase matching layer, including a buffer layer having a constant refractive index (RI) in accordance with some embodiments.

FIG. 8 is a diagram illustrating a cross-sectional view of a reflective waveguide mirror implementing a phase matching layer having a gradient of RI in accordance with some embodiments.

FIG. 9 is a diagram illustrating a cross-sectional view of a reflective waveguide mirror implementing one or more structured phase matching layers in accordance with some embodiments.

FIG. 10 is a diagram illustrating a cross-sectional view of a portion of a reflective waveguide implementing phase compensating layers on total internal reflection surfaces of the waveguide in accordance with some embodiments.

FIG. 11 is a diagram illustrating a cross-sectional view of a portion of a reflective waveguide implementing apodized reflective coatings for mirrors in accordance with some embodiments.

FIG. 12 is a graph illustrating an example modular transfer function calculated for a reflective waveguide having the apodized reflective coatings of FIG. 11 in accordance with some embodiments.

FIG. 13 is a diagram illustrating a top view of reflective waveguide mirrors implementing a serrated edge structure for phase step compensation in accordance with some embodiments.

FIG. 14 is a diagram illustrating a rear perspective view of an augmented reality display device implementing reflective waveguide portions manufactured using a crystalline mold structure in accordance with some embodiments.

FIG. 15 is a diagram illustrating a cross-section view of an example implementation of a waveguide in accordance with some embodiments.

### DETAILED DESCRIPTION

A reflective waveguide designed for pupil expansion integrates a series of partially reflective mirrors to guide light towards the user's eyebox. These mirrors are typically composed of either multiple thin film dielectric layers or a mix of metal and dielectric coatings, with the overall thickness of each mirror ranging from, for example, 200 nanometer (nm) to 4 micrometers (μm). The mirrors' reflective capabilities are carefully calibrated in relation to wavelength and angle to optimize the display's efficiency and ensure uniformity. On average, the reflectivity of each mirror varies between, for example, 5% and 25% across different display angles and wavelengths. A light ray emitted from the display's light engine is projected to pass through a number of these mirrors (e.g., 4 to 40 mirrors) before the light ray reaches the eyebox. The requirement that the ray needs to pass multiple mirrors on its way to the eye imposes additional constraints on the design of the coating.

For example, when light passes through a mirror or reflective surface within the waveguide, the light undergoes a change known as a “phase step”. Light can be characterized by its wavelength, frequency, and phase. The phase describes the position of the wave's peaks and troughs at a given point in time. When light travels through materials with different optical properties (such as air, glass, or reflective surfaces), its speed changes, which can lead to a change in phase. A “phase step” occurs when there is a sudden change in the phase of the light wave, caused by its transmission through a reflective surface within the waveguide. This phase step is relative to the light that travels directly through the core material of the waveguide without interacting with the reflective surface.

The consequence of this phase step is significant for the quality of the image produced by the waveguide. Since the light that has passed through the mirror is out of phase with the light that has traveled directly through the core material, it can interfere destructively when these light paths recombine. This interference can blur the image, reduce its resolution, and decrease its overall sharpness, leading to a significant reduction in the display quality. Essentially, the coherent properties of light, which are crucial for producing clear and sharp images, are disrupted, resulting in a less satisfactory visual experience for the user.

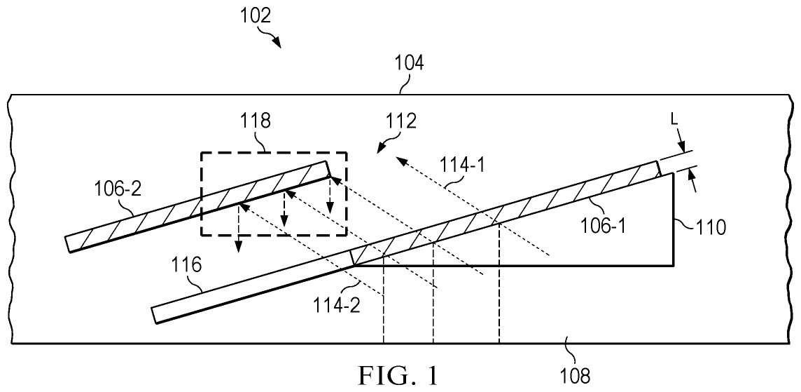

FIG. 1 shows an example of the phase step issue caused by the semi-transparent mirrors of a pupil-expanding reflective waveguide 102 (herein referred to as “waveguide 102”). In FIG. 1, a portion 104 of the waveguide 102 is shown that includes a first partially reflective mirror 106-1 (herein referred to as the “first mirror 106-1”), a second partially reflective mirror 106-2 (herein referred to as the “second mirror 106-2”), and a core 108. Each of the mirrors 106 is formed on an angled facet 110 (only one is shown for brevity), and the core 108 includes a material such as a polymer. A signal from a single display pixel propagates inside the waveguide 102 as a collimated beam 112, illustrated as a bundle of rays in FIG. 1. As the light passes through the first mirror 106-1, one or more portions 114-1 of the beam 112 travel through the first mirror 106-1, and one or more portions 114-2 of the beam travel through a non-mirror region 116 (e.g., polymer, glass, or the like) of the waveguide 102 around the first mirror 106-1. In the example shown in FIG. 1, the non-mirror region 116 has an equivalent thickness of material (e.g., polymer) to that of the first mirror 106-1. The different portions 114 of the beam 112 accumulate different amounts of phase, resulting in a phase step inside the beam after the first mirror 106-1, as represented by the dashed box 118. In the first order approximation, the phase step equals

$$2 \times π \times L \times ( \frac{\vert {n}_{coating} - {n}_{core} \vert}{λ} ) ,$$

where L is the thickness of the mirror, n_{coating} is the average refractive index of the mirror, n_{core} is the refractive index of the polymer, and λ is the wavelength of light. The actual phase step varies from this approximation and can be calculated using, for example, Rigorous Coupled-Wave Analysis (RCWA) or Finite-Difference Time-Domain (FDTD) simulation code. As the beam reflects from the second mirror 106-2 towards the user's eye, the beam includes this phase step, which negatively affects the point spread function (PFS) and modular transfer function (MTF) of this display pixel.

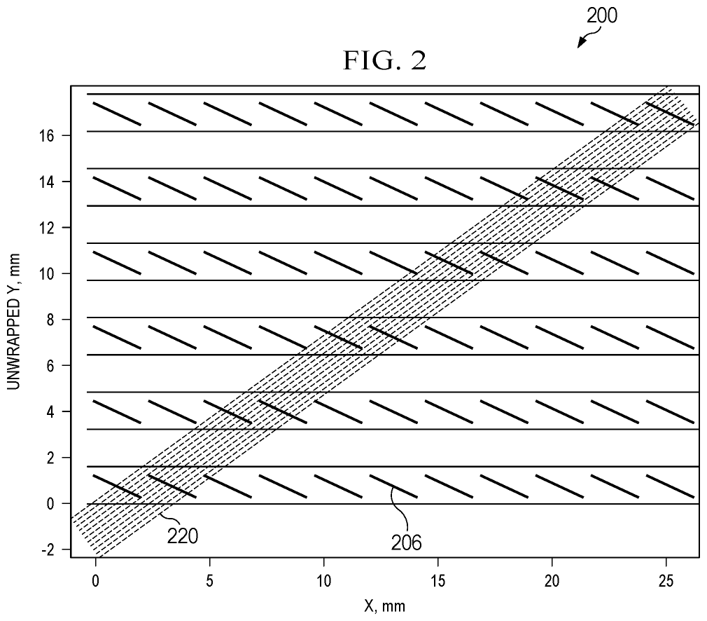

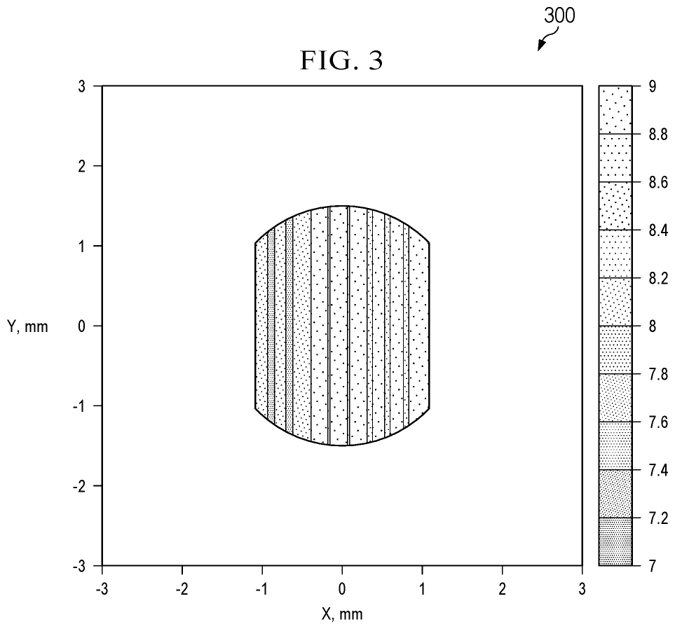

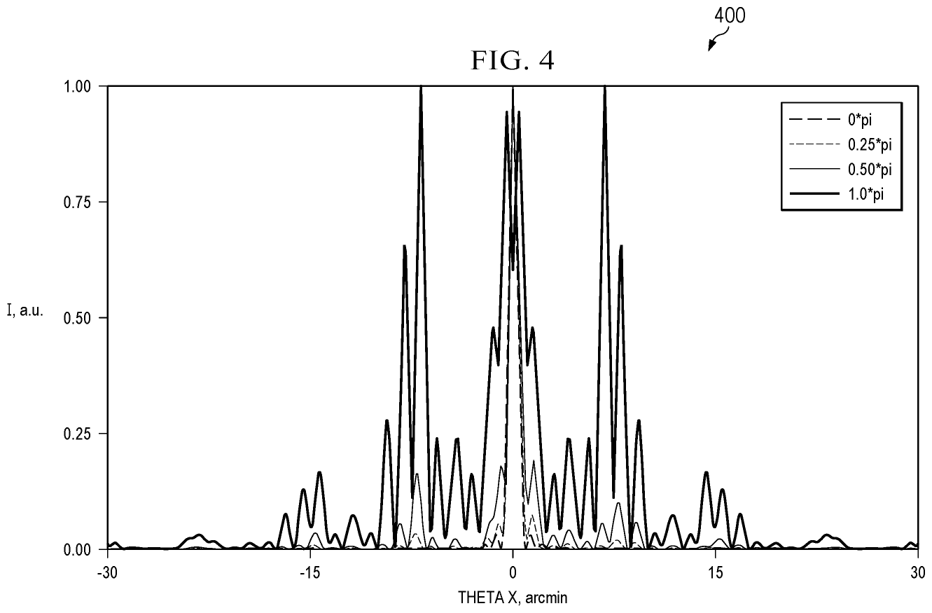

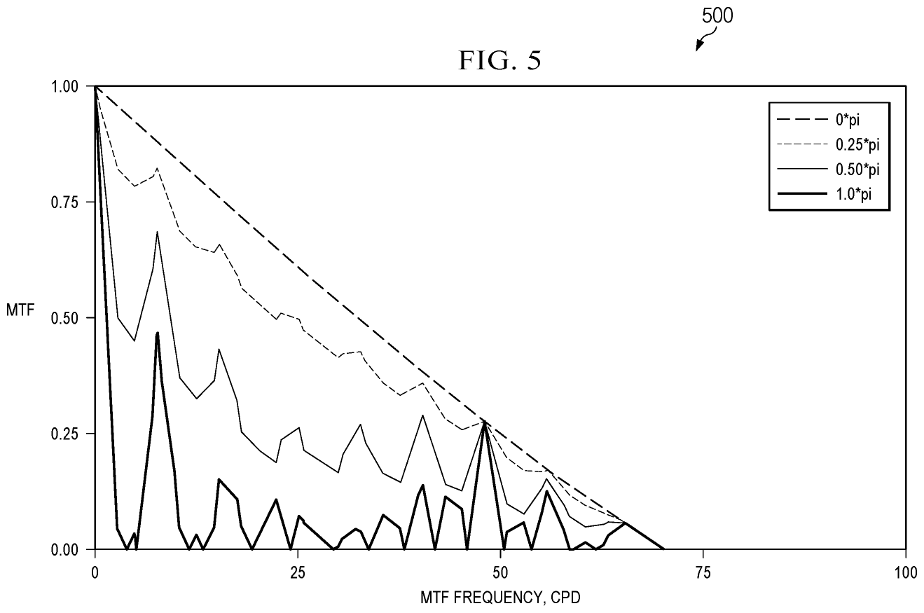

As an example, the impact of the phase step on the image quality can be estimated by retracing the rays as they propagate along the 25 millimeter (mm) long waveguide section into a 1.6 mm thick waveguide and for mirrors occupying the central 1 mm region of the waveguide. One example of this propagation path 200 along a one dimensional (1D) reflective waveguide is shown in FIG. 2, which illustrates a plurality of mirrors 206 and a plurality of rays 220. The path 200 in FIG. 2 is unfolded with respect to the total internal reflection (TIR) from the waveguide surfaces. That is, when the light experiences the TIR reflection, a ray 220 in FIG. 2 continues straight, and the waveguide is instead mirror-reflected with respect to the TIR surface. FIG. 3 is a graph 300 that shows the number of times each ray within a beam intersects a mirror surface. If this number is multiplied by the phase step caused by the transmission through a single mirror, the result is the phase distribution across the output pupil. A Fourier transform is applied to the phase distribution across the pupil, resulting in the point spread function 400 shown in FIG. 4 calculated for different values of the individual mirror phase step, which is used to calculate the MTF 500 shown in FIG. 5 for different amounts of individual mirror phase step.

As can be seen from FIG. 4 and FIG. 5, even a phase step of just 0.5*π per mirror significantly reduces image sharpness. Thus, addressing the phase step issue is essential to maintain high image quality in reflective waveguides. The detrimental impact of the phase step escalates with the increase in light-mirror interactions. This makes phase step mitigation increasingly important for reflective waveguides equipped with two-dimensional (2D) pupil expansion, which feature two mirror regions: the exit pupil expander (EPE) and the outcoupler (OC). Moreover, the importance of mitigating this effect is accentuated in thinner waveguides, where a denser arrangement of mirrors exists within the same propagation distance, exacerbating the negative impact.

Accordingly, described herein are example techniques and waveguide configurations for mitigating phase step effects within a reflective waveguide. As described in greater detail below, these phase step mitigation techniques include one or more of implementing mirrors that are phase matched to the surrounding waveguide core, implementing tapered or serrated mirrors, or implementing phase compensating layers on the surface of the waveguide, or the like. As such, by mitigating the phase difference between portions of a light beam travelling through a mirror region of a waveguide and portions of the light beam travelling through a non-mirror region of the waveguide, which increases the image quality of the displayed image.

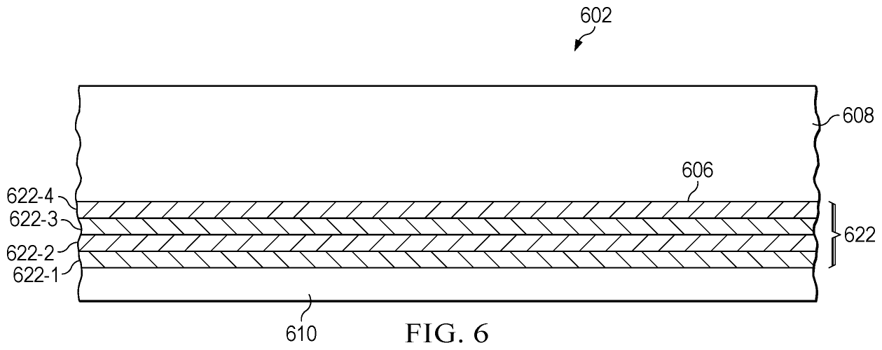

FIG. 6 illustrates a phase step mitigation technique or configuration implementing phase matching between the mirror coating and waveguide core material. For example, FIG. 6 shows a cross-sectional view of a portion of a waveguide 602 that includes a partially reflective mirror 606 (herein referred to as “mirror 606”) in a mirror region. In this configuration, the material(s) defining the mirror 606 is phased matched with the material of the waveguide core 608 (also referred to herein as “core region 608” or “non-mirror region 608”) around the mirror 606. In at least some embodiments, the mirror 606 is formed by depositing a reflective layer 622 on a substrate 610 (also referred to herein as “mirror substrate 610”), such as an angled facet of an optical element (e.g., an EPE, an OC, or the like). In at least some embodiments, the mirror substrate 610 is comprised of the same (or different material) as the waveguide core 608, such as polymer, glass, or the like. The reflective layer 622 includes a single layer or a stack of multiple layers (illustrated as layers 622-1 to 622-4). The reflective layer(s) 622 of the mirror 606 is deposited on the substrate 610 (and each other) through one or more techniques, such as physical vapor deposition (PVD), chemical vapor deposition (CVD), atomic layer deposition (ALD), or the like. In at least some embodiments, post-deposition treatments, such as annealing, are performed to enhance crystalline structure, optical properties, and substrate adhesion of the reflective layer 622.

In at least some embodiments, the reflective layer 622 of the mirror 606 is phased matched with the waveguide core 608. Stated differently, the average (by volume) refractive index (RI) of the reflective layer 622 is such that the mirror 606 is phased matched with the waveguide core 608. For example, consider a configuration in which the reflective layer 622 includes interleaved layers of high index and low index materials. In this example, the low index material has refractive index of 1.45, and the high index material has refractive index of 1.75, where the total thickness of all the low index layers is 400 nm and the total thickness of all high index layers is 200 nm. Therefore, the average index of the reflective layer 622 is 1.55 ((1.45*400+1.75*200)/600). If the waveguide core 608 has a refractive index of 1.55, then the coating is considered phase matched in the first approximation. By phase matching the reflective layer 622 to the waveguide core 608, the light propagating through the mirror 606 acquires the same phase step as the light propagating through the waveguide core 608 around the mirror 606. As such, the reflective material 622 of the mirror acts as a mitigation element for mitigating a phase difference between a first beam portion passing through the mirror 606 and a second beam portion passing through a non-mirror region of the waveguide. Considering the first order approximation, this means that the average RI of the mirror 606 matches that of the waveguide core 608. As used herein, the terms “index matched” and “phase matched” are employed interchangeably, although, in at least some cases, slight differences may exist between the actual and predicted phase of light passing through the mirror based on the average RI of the coating.

The phase step introduced by the mirror 606 when light passes through is directly correlated to the optical path length difference caused by the light traveling through different materials, i.e., the reflective layer 622 versus the material (e.g., polymer or glass) of the waveguide core 608. This phase step is a function of the difference in refractive indices between the waveguide core 608 and the reflective layer 622 of the mirror and the thickness of the reflective layer 622. Therefore, in at least some embodiments, the waveguide core 608 and the reflective layer 622 satisfy the following condition:

$$△ n \times {t}_{coating} = \vert {n}_{core} - {n}_{coating} \vert \times {t}_{coating} < k π \qquad ( EQ . 1 )$$

$$with$$

$$k < 0.3$$

$$and$$

$${t}_{coating} < 10 μm ,$$

where n_{core} and n_{coating} are the refractive index of the waveguide core 608 and the average RI of the reflective layer 622, respectively, t_{coating} is the thickness of the reflective layer 622, and k is a coefficient that limits the phase difference introduced by the reflective layer 622. In at least some embodiments, this condition is implemented by using a waveguide core 608 with a higher RI (e.g., 1.6 to 1.9) in order to increase the latitude in properties of the reflective layer 622

In other embodiments, the reflective layer 622 is configured such that the phase difference is not zero but, instead, is a multiple of 2π (phase=2×π×n, where n is an integer number). Also, in at least some embodiments, the average RI of the reflective layer 622 is greater than the average RI of the material defining the waveguide core 608. Moreover, the reflective layer 622 is further designed to match a specific angular and spectral reflectance curve to achieve good display uniformity and efficiency.

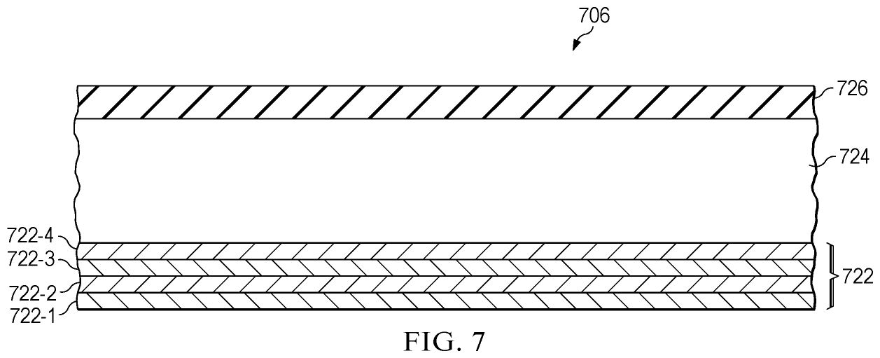

FIG. 7 illustrates a phase step mitigation technique or configuration implementing a hybrid phase matching layer with a buffer layer having a constant RI. For example, FIG. 7 shows a cross-sectional view of a partially reflective mirror 706 (herein referred to as “mirror 706”). In at least some embodiments, the mirror 706 includes a reflective layer 722 having one or more buffer layers 724 and one or more phase matching layer 726 formed thereon. The reflective layer 722 includes a single layer or multiple layers (illustrated as layers 722-1 to 722-4) that are formed on a substrate (e.g., substrate 610 of FIG. 6), such as an angled facet of an optical element (e.g., an EPE, an OC, or the like). For example, one or more materials are deposited onto the substrate through various techniques. Examples of these materials include metals (e.g., aluminum, silver, gold, or the like), dielectrics (e.g., silicon dioxide, titanium dioxide, or the like), a combination thereof, or the like. Examples of the deposition techniques include physical vapor deposition (PVD), chemical vapor deposition, atomic layer deposition (ALD), or the like. The reflective layer 722, in at least some embodiments, is formed as a thin-film reflective layer. In at least some embodiments, the reflective layer 722 is formed without any consideration for phase matching but achieves one or more desired reflectance properties. In at least some embodiments, post-deposition treatments, such as annealing, are performed to enhance crystalline structure, optical properties, and substrate adhesion of the reflective layers 722.

The buffer layer 724 is formed on and, in at least some embodiments, in direct contact with the reflective layer 722. One or more deposition techniques, such as CVD, PVD, ALD, spin coating, or the like, are used to form the buffer layer 724. In at least some embodiments, the buffer layer 724 includes one or more dielectric or other materials, such as metal oxides (silicon, silicon dioxide, aluminum oxide, titanium dioxide, hafnium oxide, polymers, indium tin oxide, or the like.), fluorides (magnesium fluoride, lanthanum trifluoride, etc.), semiconductors (silicon gallium arsenide, indium phosphide, etc.), metals (aluminum, silver, etc.), and polymers, or the like. However, the material defining the buffer layer 724 has the same RI as the material (e.g., polymer or glass) defining the waveguide core (e.g., waveguide core 608 of FIG. 6) around the mirror 706. In at least some embodiments, the buffer layer 722 has a thickness of at least 3 μm. However, other thicknesses are applicable as well

The phase matching layer 726 is formed on and, in at least some embodiments, in direct contact with the buffer layer 724. One or more deposition techniques, such as CVD, PVD, ALD, spin coating, or the like, are used to form the phase matching layer 726. The phase matching layer 726 includes one or more materials such as metal oxides, silica, titanium dioxide, silicon nitride, tantalum pentoxide, magnesium fluoride, polymers, hybrid organic-inorganic materials, or the like. However, the thickness of the phase matching layer 726 and the RI of the material(s) defining the phase matching layer 726 is such that the average RI of the entire stack (i.e., the reflective layer 722, the buffer layer 724, and the phase matching layer 726) matches the RI of the material defining the waveguide core around the mirror 706. As such, the phase matching layer 726 acts as a mitigation element for mitigating a phase difference between a first beam portion passing through the mirror 706 and a second beam portion passing through a non-mirror region of the waveguide.

Nominally, adding a phase-matching layer to the reflective layer 722 would significantly modify the reflection properties mirror 706. However, this is avoided by adding the buffer layer 724 between the reflective layer 722 and the phase matching layer 726. Also, in at least some embodiments, the thickness of the buffer layer 724 is greater (e.g., >˜10 μm) than the coherence length of an image source (e.g., light emitting diode (LED), ensuring that the average (across LED spectrum) effect of the phase matching layer 726 on the reflection of the entire stack is close to zero. In at least some embodiments, the thickness of the buffer layer 724 is dithered between subsequent mirrors to ensure that different wavelengths within the LED spectrum are depleted at the same rate. In at least some embodiments, the mirror 706 and the phase matching layer 726 could be fabricated on the opposite halves of the waveguide that are bonded together. In this configuration, the bonding glue acts as the buffer layer 724 and has a thickness that is greater than the coherence length of the display projector source.

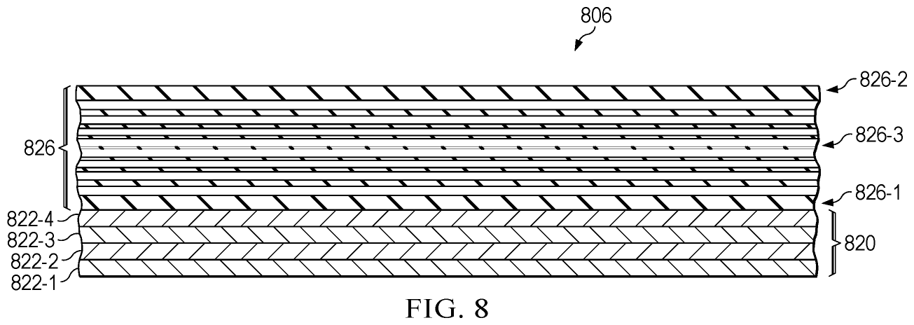

FIG. 8 illustrates a phase step mitigation technique or configuration implementing a phase matching layer having a gradient of RI. For example, FIG. 8 shows a cross-sectional view of a partially reflective mirror 806 (herein referred to as “mirror 806”). In at least some embodiments, the mirror 806 includes a reflective layer 822. The reflective layer 822 includes a single layer or multiple layers (illustrated as layers 822-1 to 822-4) that are formed on a substrate (e.g., substrate 610 of FIG. 6), such as an angled facet of an optical element (e.g., an IC, an EPE, an OC, or the like). For example, one or more materials are deposited onto the substrate through various techniques. Examples of these materials include metals (e.g., aluminum, silver, gold, or the like), dielectrics (e.g., silicon dioxide, titanium dioxide, or the like), a combination thereof, or the like. Examples of the deposition techniques include physical vapor deposition (PVD), chemical vapor deposition, atomic layer deposition (ALD), or the like. The reflective layer 822, in at least some embodiments, is formed as a thin-film reflective layer. In at least some embodiments, the reflective layer 822 is formed without any consideration for phase matching but achieves one or more desired reflectance properties. In at least some embodiments, post-deposition treatments, such as annealing, are performed to enhance crystalline structure, optical properties, and substrate adhesion of the reflective layers 822.

One or more phase matching layers/coatings 826 formed on and, in at least some embodiments, in direct contact with the reflective layer 822. The phase matching layer 826 includes a single layer of material or multiple layers of the same or different materials. One or more deposition techniques, such as CVD, PVD, ALD, spin coating, or the like, are used to form the phase matching layer 826. The phase matching layer 826 includes one or more materials such as silica, titanium dioxide, silicon nitride, tantalum pentoxide, magnesium fluoride, polymers, hybrid organic-inorganic materials, or the like. However, instead of having a constant RI, the phase matching layer 822 has a gradient of RI. For example, the RI at a first portion 826-1 (e.g., a starting portion) and a second portion 826-2 (e.g., an ending portion) of the phase matching layer 826 (i.e., at opposing portions that are farthest from and closest to the reflective layer 822) is the same as the RI of the material defining the core region (e.g., waveguide core 608 of FIG. 6) around the mirror 806, but the RI gradually changes towards the center 826-3 of the phase matching layer 826. As an example, the RI changes from 1.6 to 1.45, then back to 1.6 if the average RI of the reflective layer 822 is being reduced. In another example, the RI changes from 1.6 to 1.9, then back to 1.6 if the average RI of the reflective layer 822 is being increased. This way, the average RI of the phase matching layer is different from that of the waveguide core material. Therefore, the RI of the phase matching layer 826 is tunable such that the entire mirror stack (e.g., the reflective layer 822 and the phase matching layer 826) is phase matched to the material of the waveguide core.

Also, due to the gradual change of the RI, the phase matching layer 826, by itself, does not reflect almost any light and, therefore, does affect the reflection properties of the reflective layer 822. In at least some embodiments, the gradient RI of the phase matching layer 826 is achieved by either gradually changing the material composition or by depositing thin alternating layers of the two different materials and changing the ratio of the thicknesses of these layers. However, other techniques are also applicable. As such, the phase matching layer 826 acts as a mitigation element for mitigating a phase difference between a first beam portion passing through the mirror 806 and a second beam portion passing through a non-mirror region of the waveguide.

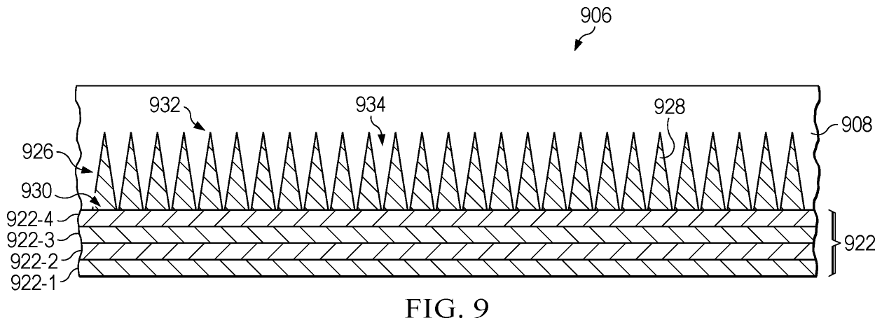

FIG. 9 illustrates a phase step mitigation technique or configuration implementing one or more structured phase matching layers. For example, FIG. 9 shows a cross-sectional view of a partially reflective mirror 906 (herein referred to as “mirror 906”). The mirror 906 includes a reflective layer 922 having one or more phase matching layers/coatings 926 formed thereon. The reflective layer 922 includes a single layer or multiple layers (illustrated as layers 922-1 to 922-4) that are formed on a substrate (e.g., substrate 610 of FIG. 6), such as an angled facet of an optical element (e.g., an IC, an EPE, an OC, or the like). In at least some embodiments, the reflective layer 922 is formed without any consideration for phase. However, the medium/material (top, infinite thickness layer) of the reflective layer 922, in at least some embodiments, has an RI that is different from the RI of the material (e.g., polymer or glass) defining the waveguide core 908 (also referred to herein as “core region 908” or “non-mirror region 908”) around the mirror 906.

The reflective layer(s) 922 is formed by depositing one or more materials onto the substrate through various techniques. Examples of these materials include metals (e.g., aluminum, silver, gold, or the like), dielectrics (e.g., silicon dioxide, titanium dioxide, or the like), a combination thereof, or the like. Examples of the deposition techniques include physical vapor deposition (PVD), chemical vapor deposition, atomic layer deposition (ALD), or the like. The reflective layer 922, in at least some embodiments, is formed as a thin-film reflective layer. In at least some embodiments, post-deposition treatments, such as annealing, are performed to enhance crystalline structure, optical properties, and substrate adhesion of the reflective layer 922.

In the configuration shown in FIG. 9, the phase matching layer(s) 926 is a structured layer, such as moth-eye layer. This structured layer, in at least some embodiments, is configured on the nanometer scale, although other scales are applicable as well. In at least some embodiments, the structures (e.g., moth-eye structures) of the structured phase matching layer(s) 926 have a sub-wavelength period (e.g., periods less than λ/2). The structured phase matching layer(s) 926 is formed on and, in at least some embodiments, in direct contact with the thin reflective layer 922 using one or more materials and deposition/fabrication techniques. Examples of the materials for the structured phase matching layer(s) 926 include metal oxides (e.g., silicon dioxide, titanium dioxide, indium tin oxide, etc.), fluorides (e.g., magnesium fluoride, lanthanum trifluoride, etc.), semiconductors (e.g., silicon, gallium arsenide, indium phosphide, etc.), metals (aluminum, silver, etc.), and the like. However, in at least some embodiments, the material of the structured phase matching layer has the same RI as the medium of the reflective layer 922.

In at least some embodiments, the structured phase matching layer(s) 926 is formed on the reflective layer 922 using one or more fabrication techniques such as nanoimprint lithography (NIL), reactive ion etching (RIE), and the like. For example, during NIL, a layer of matching material for the structured phase matching layer(s) 926 is deposited on the reflective layer 922. A stamp or mold with the desired nanostructured pattern (representing the moth-eye structure) is fabricated, using electron beam lithography or other high-precision techniques. A thin layer of resist (e.g., a light-sensitive or thermoplastic material) is applied to the surface of the phase matching layer material where the pattern is to be transferred. The prepared stamp is pressed into the resist layer under controlled conditions of temperature and pressure. This physically deforms the resist, transferring the pattern from the stamp to the phase matching layer material. The resist is cured through ultraviolet (UV) exposure (for photopolymerizable resists) or heating (for thermoplastic resists), solidifying the pattern. The stamp is removed, leaving behind the resist patterned with the nanostructures resembling the structured (e.g., moth-eye) surface. The patterned resist can then serve as a mask for etching the underlying phase matching layer material, transferring the pattern onto it. This etching can be performed using, for example, RIE.

As shown in FIG. 9, the resulting structured phase matching layer(s) 926 includes a plurality of protrusions 928 extending outwardly from the reflective layer 922, with each protrusion 928 including a base 930 proximal to the reflective layer 922 and a tip 932 distal to the reflective layer 922. FIG. 9 further shows that the material of the waveguide core 908 fills the interstitial space 934 (or inter-protrusion space) between each of the protrusions 928. The material of the waveguide core 908 also extends beyond the tips 932 of the protrusions 928 in a direction opposite to the base 930 of the protrusions 928. As such, the structured phase matching layer(s) 926 gradually transitions from the RI of the medium of the reflective layer 922 medium to the RI of the waveguide core 910 around the mirror. As a result of this gradual transition, the structured phase matching layer(s) 926 itself does not reflect any light and, thus, does not affect the reflectance properties of the reflective layer 922. In at least some embodiments, the thickness of the structured phase matching layer(s) 926 is dimensioned such that the phase of the entire mirror stack (i.e., the reflective layer 922 and structured phase matching layer(s) 926) is matched to the phase of the waveguide core 910. As such, the structured phase matching layer 926 acts as a mitigation element for mitigating a phase difference between a first beam portion passing through the mirror 906 and a second beam portion passing through a non-mirror region of the waveguide.

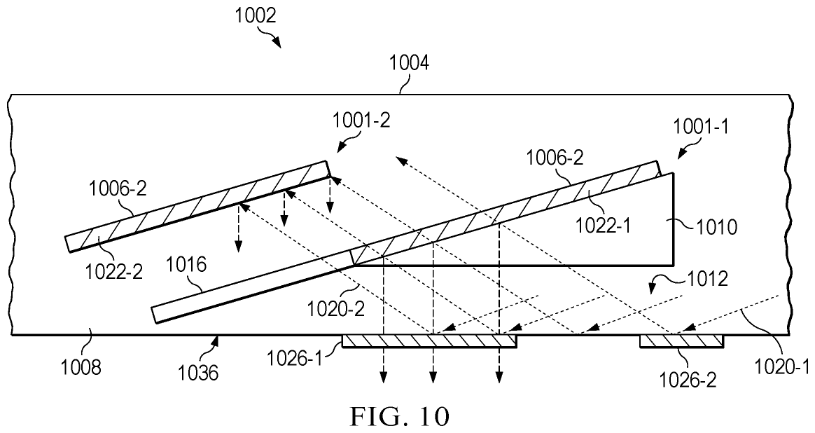

FIG. 10 illustrates a phase step mitigation technique or configuration implementing phase compensating layers on TIR surfaces of the waveguide. For example, FIG. 10 shows a cross-sectional view of a portion 1004 of waveguide 1002 including a first partially reflective mirror 1006-1 (herein referred to as “first mirror 1006-1”) in a first mirror region 1001-1, a second partially reflective mirror 1006-2 (herein referred to as “second mirror 1006-2”) in a second mirror region 1001-2, a waveguide core 1008 (also referred to herein as “core region 1008” or “non-mirror region 1008”), a mirror substrate 1010 (also referred to herein as “substrate 1010”), and a collimated beam 1012 (illustrated as a bundle of rays). Each of the mirrors 1006 includes a reflective layer 1022 (illustrated as reflective layer 1022-1 and reflective layer 1022-2), which is either a single layer or multiple layers. The reflective layer 1022 is formed on the substrate 1010, such as an angled/tilted facet, by depositing one or more materials thereon and using techniques such as those described above with respect to FIG. 6 to FIG. 9.

FIG. 10 further shows that one or more phase compensating layers 1026 (illustrated as phase compensating layer 1026-1 and phase compensating layer 1026-2) are formed on TIR surfaces 1036 of the waveguide 1002. For example, a phase compensating material is deposited onto the TIR surfaces 1036 of the waveguide 1002. This can be achieved through various deposition techniques such as CVD, PVD, spin coating, sputtering, or the like. Examples of the phase compensating material include silica, titanium dioxide, silicon nitride, tantalum pentoxide, magnesium fluoride, polymers, hybrid organic-inorganic materials, or the like. In at least some embodiments, the phase compensating material is patterned to form/define the phase compensating layer(s) 1026. The patterning, in at least some embodiments, is performed using, for example, photolithography or electron beam lithography, where a mask is used to selectively expose areas of the phase compensation material to light or electrons, followed by a development process to remove the unwanted material. After patterning, etching processes, such as RIE or wet chemical etching, can be used to fine-tune the shape and depth of the phase compensating layers 1026.

In at least some embodiments, an analysis similar to that described above with respect to FIG. 2 is performed to identify which rays of the beam 1012 need the additional phase step, and the phase compensating layers 1026 are formed at the corresponding locations on the TIR surfaces 1036 of the waveguide 1002. In some embodiments, these locations are different for different propagation angles. The configuration shown in FIG. 10 considerably reduces the effect of the phase steps for the average propagation angle. For example, as a ray 1020-1 of the beam 1012 reflects off a boundary of a TIR surface 1036 at which a phase compensating layer 1026 is located, the phase compensating layer 1026 changes the phase imparted on the ray 1020-1. The phase compensating layer 1026 acts as a mitigation element configured to change the phase step of the ray 1020-1 such that when the ray 1020-1 travels through the first mirror 1006-1 and acquires another phase step, this subsequent phase step is matched to the phase step of a ray 1020-2 that travels through a non-mirror region 1016 (e.g., polymer, glass, or the like) of the waveguide 1002 around the first mirror 1006-1. Stated differently, the phase compensating layer 1026 mitigates a phase difference between the rays 1020 passing through the mirror 1006 and the non-mirror region 1016 of the waveguide 1002. Also, since the light interacts with the TIR surface 1036 at an oblique angle, only a very thin phase compensating layer 1026 is required to achieve a significant phase step. This means that such a layer does not significantly affect the see-through properties of the waveguide 1002.

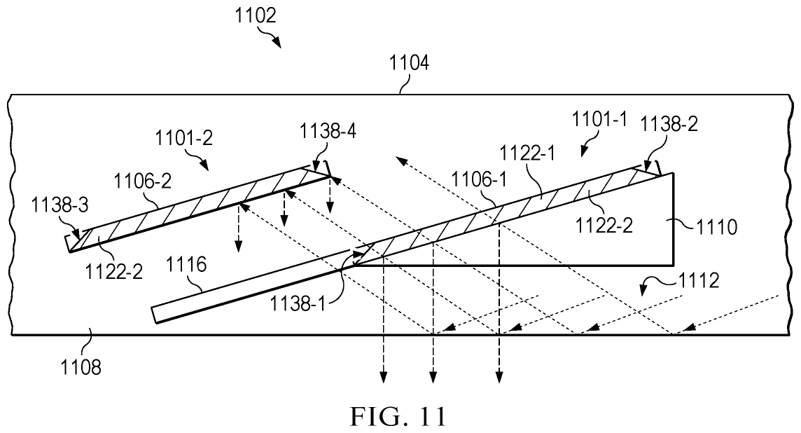

FIG. 11 illustrates a phase step mitigation technique or configuration implementing apodized reflective coatings for the mirrors to compensate for the phase step. For example, FIG. 11 shows a cross-sectional view of a portion 1104 of waveguide 1102 including a first partially reflective mirror 1106-1 (herein referred to as “first mirror 1106-1”) in a first mirror region 1101-1, a second partially reflective mirror 1106-2 (herein referred to as “second mirror 1106-2”) in a second mirror region 1101-2, a waveguide core 1108 (also referred to herein as “core region 1108” or “non-mirror region 1108”), a mirror substrate 1110 (also referred to herein as “substrate 1110”), a collimated beam 1112 (illustrated as a bundle of rays), and a non-mirror region 1116. Each of the mirrors 1106 is formed on the substrate 1110, such as an angled/tilted facet, and includes a reflective layer 1122 (illustrated as reflective layer 1122-1 and reflective layer 1122-2), which is either a single layer or multiple layers. The reflective layer 1122, in at least some embodiments, is an apodized layer. As such, the thickness of the reflective layer 1122, and, therefore, phase step, slowly tapers at both edges 1138 (illustrated as edge 1138-1 to edge 1138-4) of the mirror 1106.

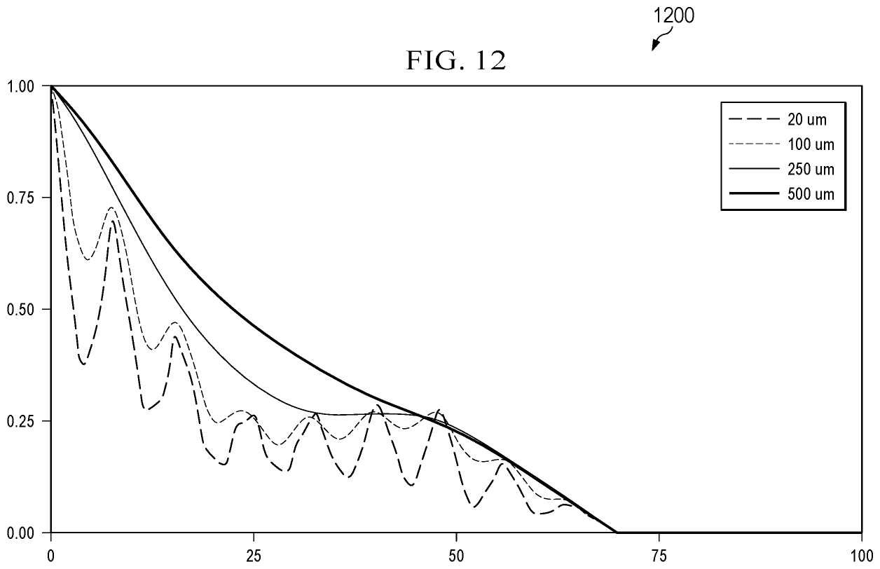

Techniques and materials, such as those described above with respect to FIG. 6 to FIG. 9, are used to form the reflective layer 1120, including coating the mirror 1106 with layers of materials that have different reflective properties or by physically etching or shaping the mirror surface. The apodized configuration of the mirrors 1106 leads to a more uniform distribution of the phase acquired by different ray paths through the waveguide. This can mitigate the effect of the phase step on the MTF as illustrated in FIG. 12, which shows MTF curves 1200 for a reflective waveguide with 0.5π phase step through the center of the (louver) mirror having a different amount of the length of thickness taper at the edge of the mirror. As such, the apodized reflective layer 1120 mitigates a phase difference between the rays of the beam 1112 passing through the mirror 1006 and the non-mirror region 1116 of the waveguide 1102.

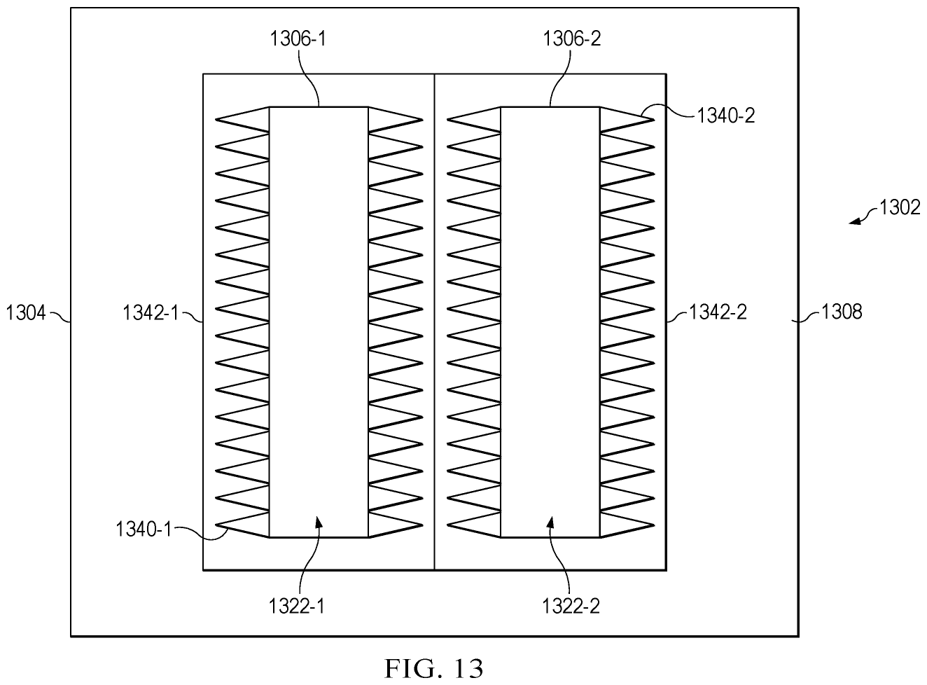

FIG. 13 illustrates a phase step mitigation technique or configuration implementing serrated reflective coatings for the mirrors to compensate for the phase step. For example, FIG. 13 shows a top view of a portion 1304 of waveguide 1302 including a first partially reflective mirror 1306-1 (herein referred to as “first mirror 1306-1”), a second partially reflective mirror 1306-2 (herein referred to as “second mirror 1306-2”), a waveguide core 1308 (also referred to herein as “core region 1308” or “non-mirror region 1308” or), and a mirror substrate 1310 (also referred to herein as “substrate 1310”). Each of the mirrors 1306 is formed on the substrate (not shown), such as an angled/tilted facet, and includes a reflective layer 1322 (illustrated as reflective layer 1322-1 and reflective layer 1322-2), which is either a single layer or multiple layers. The reflective layer 1322, in at least some embodiments, is configured such that the mirror 1306 has serrated edges 1340 (illustrates as edges 1340-1 and edges 1340-2). For example, instead of gradually reducing the thickness of the mirror 1306 as described above with respect to FIG. 11, the thickness of the mirror 1306 is kept the same, but the fraction of the area that is occupied by the mirror 1306 gradually tapers down.

The serrated edges 1340 influence the phase step of the reflected light through diffraction and interference. The presence of serrations causes the light waves to diffract, which is the spreading out of waves when they encounter obstacles or apertures comparable to their wavelength. In this context, each serration acts as an obstacle, altering the direction and phase of the light waves. As these diffracted waves from the serrations interfere with each other, either constructively or destructively, based on their relative phases, this interference pattern introduces variations in the phase step of the reflected light. The impact of serrated edges 1340 on the phase step is directly linked to their geometric characteristics, such as shape, depth, and spacing. In at least some embodiments, the phase step varies across the surface of the mirrors 1306, depending on the design of the serrated edges 1340. As such, the serrated edges 1340 acta as a mitigation element for mitigating a phase difference between a first beam portion passing through the mirror 1306 and a second beam portion passing through a non-mirror region of the waveguide.

Techniques and materials, such as those described above with respect to FIG. 6 to FIG. 9, are used to form the reflective layer 1320. For example, photolithography is used to transfer a serration pattern onto deposited material forming the mirror surface. An etching process, such as RIE, is then performed to remove material where the serrations are to be formed. In another example, laser ablation is performed to precisely remove material from the edge of the mirror 1306 to form the serrations, which extend toward the prism boundary 1342 (illustrated as boundary 1342-1 and boundary 1342-2). The shape of serration, in at least some embodiments, follows a triangular shape, a sinusoidal shape or a shape having two semi-circles, or the like. The serrated edge 1340, having semi-circles, scatters the light uniformly to all angles without creating any preferred directions for the scatter. This happens due to the fact that the light scatters in the direction of the normal to the serrated edge 1340 at each point along the edge 1340. The circle does not have a preferred direction for the normal.

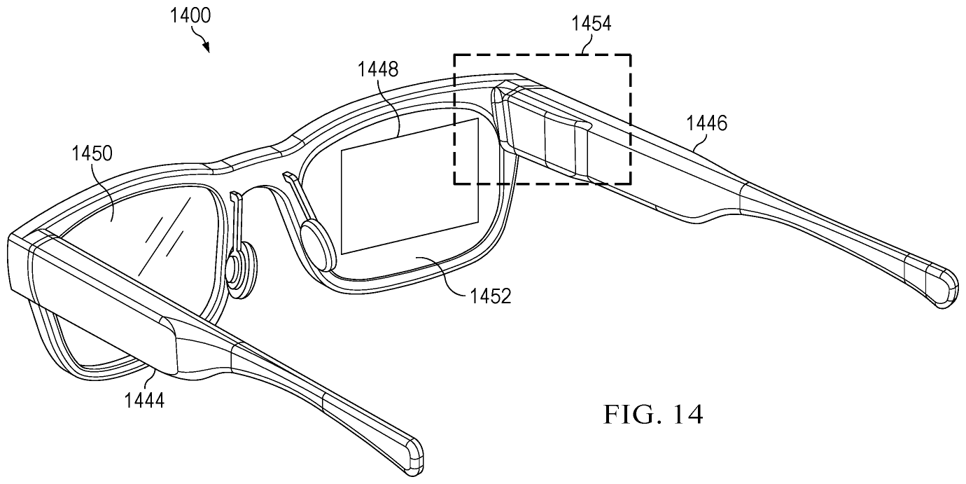

FIG. 14 illustrates an example AR eyewear display system 1400 implementing a reflective waveguide having one or more of the phase step matching/compensating configurations described above with respect to FIG. 6 to FIG. 13. The AR eyewear display system 1400 includes a support structure 1444 (e.g., a support frame) to mount to a head of a user and that includes an arm 1446 that houses a laser projection system, micro-display (e.g., micro-light emitting diode (LED) display), or other light engine configured to project display light representative of images toward the eye of a user, such that the user perceives the projected display light as a sequence of images displayed in a field of view (FOV) area 1448 at one or both of lens elements 1450, 1452 supported by the support structure 1444. In at least some embodiments, the support structure 1444 further includes various sensors, such as one or more front-facing cameras, rear-facing cameras, other light sensors, motion sensors, accelerometers, and the like. The support structure 1444, in at least some embodiments, further includes one or more radio frequency (RF) interfaces or other wireless interfaces, such as a Bluetooth™ interface, a Wi-Fi interface, and the like.

The support structure 1444, in at least some embodiments, further includes one or more batteries or other portable power sources for supplying power to the electrical components of the AR eyewear display system 1400. In at least some embodiments, some or all of these components of the AR eyewear display system 1400 are fully or partially contained within an inner volume of support structure 1444, such as within the arm 1446 in region 1454 of the support structure 1444. In the illustrated implementation, the AR eyewear display system 1400 utilizes an eyeglasses form factor. However, the AR eyewear display system 1400 is not limited to this form factor and, thus, may have a different shape and appearance from the eyeglasses frame depicted in FIG. 14.

One or both of the lens elements 1450, 1452 are used by the AR eyewear display system 1400 to provide an AR display in which rendered graphical content can be superimposed over or otherwise provided in conjunction with a real-world view as perceived by the user through the lens elements 1450, 1452. For example, laser light or other display light is used to form a perceptible image or series of images that are projected onto the eye of the user via one or more optical elements, including a waveguide, formed at least partially in the corresponding lens element. One or both of the lens elements 1450, 1452 thus includes at least a portion of a waveguide that routes display light received by an incoupler (IC) (not shown in FIG. 14) of the waveguide to an outcoupler (OC) (not shown in FIG. 14) of the waveguide, which outputs the display light toward an eye of a user of the AR eyewear display system 1400. Additionally, the waveguide employs an exit pupil expander (EPE) (not shown in FIG. 14) in the light path between the IC and OC, or in combination with the OC, in order to increase the dimensions of the display exit pupil. Each of the lens elements 1450, 1452 is sufficiently transparent to allow a user to see through the lens elements to provide a field of view of the user's real-world environment such that the image appears superimposed over at least a portion of the real-world environment.

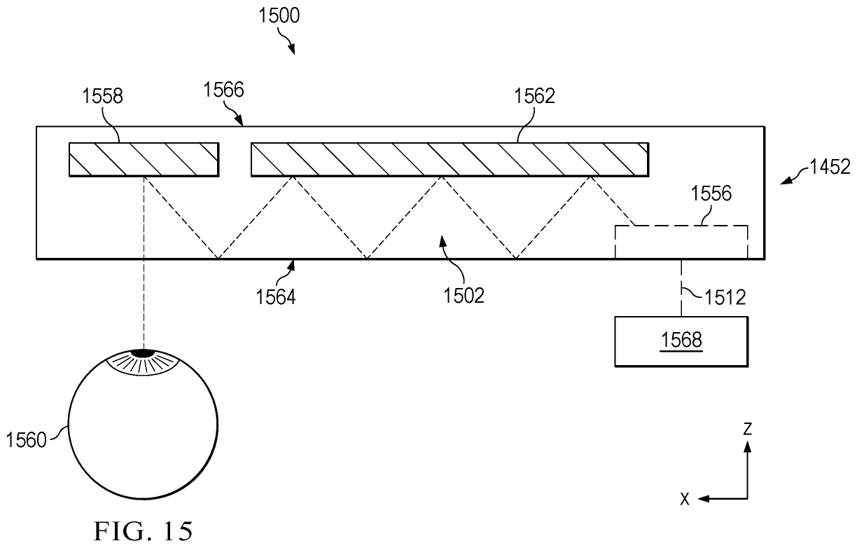

FIG. 15 depicts a cross-section view of an implementation of a display system 1500 (e.g., a near-eye display system or a wearable head-mounted display system) partially included in a lens element, such as lens element 1452, of an AR eyewear display system, such as AR eyewear display system 1400, which in some embodiments comprises a waveguide 1502. The waveguide 1502 implements one or more the phase step matching/compensating configurations described above with respect to FIG. 6 to FIG. 13. Note that for purposes of illustration, at least some dimensions in the Z direction are exaggerated for improved visibility of the represented aspects.

The waveguide 1502 includes one or more waveguide gratings, such as an incoupler 1556, an outcoupler 1558, or an exit pupil expander (EPE) 1562. The term “waveguide”, as used herein, will be understood to mean a combiner using one or more of total internal reflection (TIR), specialized filters, and/or reflective surfaces, to transfer light from an incoupler (such as the incoupler 1556) to an outcoupler (such as the outcoupler 1558). In some display applications, the light is a collimated image, and the waveguide transfers and replicates the collimated image to the eye. In general, an incoupler and outcoupler each include, for example, one or more optical grating structures, including, but not limited to, reflective gratings, diffraction gratings, holograms, holographic optical elements (e.g., optical elements using one or more holograms), volume diffraction gratings, volume holograms, surface relief diffraction gratings, and/or surface relief holograms. In at least some embodiments, a given incoupler or outcoupler is a reflective grating (e.g., a reflective diffraction grating or a reflective holographic grating) that causes the incoupler or outcoupler to reflect light and to apply designed optical function(s) to the light during the reflection. One or more of the incoupler 1556, the outcoupler 1558, or the exit pupil expander (EPE) 1562 implement the mirrors or other phase difference mitigation elements described above with respect to FIG. 6 to FIG. 13. Also, one or more of the incoupler 1556, the outcoupler 1558, or the exit pupil expander (EPE) 1562 are fabricated as part of the waveguide 1502 or are fabricated separately from the waveguide 1502 and then bonded thereto.

In the present example, the display light 1512 received at the incoupler 1556 is relayed to the outcoupler 1558 via the waveguide 1502 using TIR. The display light 1512 is then output to the eye 1560 of a user via the outcoupler 1558. As described above, in some embodiments the waveguide 1502 is implemented as part of an eyeglass lens, such as the lens 1450 or lens 1452 (FIG. 1) of the display system having an eyeglass form factor and employing the display system 1500.

In this example implementation, the waveguide 1502 implements facets in the region 1562 (which provide exit pupil expansion functionality), facets as part of the OC 1558, and facets as part of the IC 1556. The facets for these different components or regions are implemented toward the eye-facing side 1564 or the world-facing side 1566 of the waveguide 1502. Thus, under this approach, display light 1512 emitted or projected from a light source 1568 is incoupled to the waveguide 1502 via the IC 1556, and propagated (through total internal reflection in this example) toward the region 1562, whereupon the facets of the region 1562 reflect the incident display light for exit pupil expansion purposes, and the resulting light is propagated to the facets of the OC 1558, which output the display light toward a user's eye 1560.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A waveguide, comprising:
a mirror region;
a non-mirror region; and
a mitigation element to mitigate a phase difference between a first beam portion passing through the mirror region and a second beam portion passing through the non-mirror region.

2. The waveguide of claim 1, wherein the mitigation element comprises a reflective layer of the mirror region.

3. The waveguide of claim 2, wherein a refractive index of the reflective layer is matched to a refractive index of the non-mirror region.

4. The waveguide of claim 2, wherein the reflective layer and the non-mirror region satisfies:
$$△ n \times {t}_{coating} = \vert {n}_{core} - {n}_{coating} \vert \times {t}_{coating} < k π$$
$$with$$
$$k < 0.3$$
$$and$$
$${t}_{coating} < 10 micrometers ,$$
where n_{core} is a refractive index of the non-mirror region and n_{coating} is an average refractive index of the reflective layer, t_{coating} is a thickness of the reflective layer, and k is a coefficient limiting the phase difference introduced by the reflective layer.

5. The waveguide of claim 2, wherein the reflective layer is configured such that the phase difference is greater than 0 and is a multiple of 2π, where phase=2×π×n, with n being an integer number.

6. The waveguide of claim 5, wherein the reflective layer has an average refractive index that is greater than an average refractive index of the non-mirror region.

7. The waveguide of claim 1, further comprising:
a reflective layer formed in the mirror region; and
a buffer layer having a thickness of at least 3 micrometers and situated between the reflective layer and the mitigation element.

8. The waveguide of claim 7, wherein the mitigation element comprises a phase matching layer configured such that an average refractive index of the reflective layer, the buffer layer, and the mitigation element matches a refractive index of the non-mirror region.

9. The waveguide of claim 1, wherein the mitigation element comprises a phase matching layer situated on a reflective layer formed in the mirror region, and wherein the phase matching layer comprises a gradient of refractive index.

10. The waveguide of claim 9, wherein a first refractive index at a first portion of the phase matching layer closest to the reflective layer and a second refractive index at a second portion of the phase matching layer farthest from the reflective layer are the same as a refractive index of the non-mirror region, and wherein the first refractive index and the second refractive index gradually change towards a center of the phase matching layer.

11. The waveguide of claim 1, wherein the mitigation element comprises a structured phase matching layer formed on a reflective layer of the mirror region and comprising a plurality of protrusions extending outwardly from the reflective layer with each protrusion including a base proximal to the reflective layer and a tip distal to the reflective layer, and wherein a thickness of the structured phase matching layer is dimensioned such that a phase imparted on the first beam portion matches a phase imparted on the second beam portion.

12. The waveguide of claim 1, wherein the mitigation element comprises at least one phase compensating layer formed on at least one total internal reflection (TIR) surface of the waveguide.

13. The waveguide of claim 12, wherein the phase compensating layer adjusts a first phase imparted on the first beam portion such that a second phase imparted on the first portion of the light beam matches a phase of the second beam portion.

14. The waveguide of claim 1, wherein the mitigation element comprises an apodized reflective layer formed in the mirror region.

15. The waveguide of claim 1, wherein the mitigation element comprises a reflective layer formed in the mirror region having serrated edges.

16. A waveguide grating, comprising:
a substrate; and
at least one mirror formed on the substrate, the at least one mirror comprising:
at least one reflective layer formed on the substrate; and
at least one mitigation element formed on the at least one reflective layer to mitigate a phase difference between a first beam portion passing through the at least one reflective layer and a second beam portion passing through a non-mirror region of a waveguide.

17. The waveguide grating of claim 16, wherein the at least one mitigation element is a material of the at least one reflective layer having a refractive index that is matched to a refractive index of the non-mirror region.

18. The waveguide grating of claim 16, further comprising:
a buffer layer situated between the reflective layer and the at least one mitigation element.

19. The waveguide grating of claim 18, wherein the at least one mitigation element comprises a phase matching layer configured such that an average refractive index of the at least one reflective layer, the buffer layer, and the at least one mitigation element matches a refractive index of the non-mirror region.

20. A wearable head-mounted display system comprising:
the waveguide of claim 1;
an image source to project light comprising an image; and
at least one lens element.
